(19) United States
(12) Patent Application Publication
(10) Pub. No.: US 2024/0246045 A1
(43) Pub. Date: Jul. 25, 2024

(54) DEVICE FOR GENERATING OZONE-CONTAINING ULTRAFINE BUBBLE LIQUID, AND METHOD FOR GENERATING OZONE-CONTAINING ULTRAFINE BUBBLE LIQUID

(71) Applicant: CANON KABUSHIKI KAISHA, Tokyo (JP)

(72) Inventors: IKUO NAKAZAWA, Kanagawa (JP); TAKAHARU AOTANI, Tokyo (JP); YOHEI MASADA, Tokyo (JP)

(21) Appl. No.: 18/623,211

(22) Filed: Apr. 1, 2024

Related U.S. Application Data
(63) Continuation of application No. PCT/JP2022/032834, filed on Aug. 31, 2022.

(30) Foreign Application Priority Data
Oct. 13, 2021 (JP) 2021-168068

(51) Int. Cl. B01F 31/85; B01F 23/237; B01F 23/2375; B01F 101/00; C02F 1/32; C02F 1/78

(52) U.S. Cl. CPC B01F 31/85; B01F 23/2375; B01F 23/237613; C02F 1/32; C02F 1/78; B01F 2101/305; C02F 2303/04

(57) ABSTRACT

Provided are a device for generating an ozone-containing UFB liquid and a method for generating the ozone-containing UFB liquid, which enable the generation of the ozone-containing UFB liquid that can be stored long-term at a high concentration. To this end, an ultrafine bubble liquid containing ultrafine bubbles is generated by applying energy to a liquid and ejecting the liquid from an ejecting port having a small diameter, and the generated ultrafine bubble liquid is irradiated with ultraviolet ray.

### CROSS-REFERENCE TO RELATED APPLICATIONS

This application is a Continuation of International Patent Application No. PCT/JP2022/032834, filed Aug. 31, 2022, which claims the benefit of Japanese Patent Application No. 2021-168068, filed Oct. 13, 2021, both of which are hereby incorporated by reference herein in their entirety.

### BACKGROUND OF THE INVENTION

### Field of the Invention

The present invention relates to a device for generating an ozone-containing ultrafine bubble liquid and a method for generating the ozone-containing ultrafine bubble liquid.

### Background Art

In PTL 1, oxygen nano bubble water of 10 nm or greater and 500 nm or smaller in diameter is generated by generating swirl flows in water in which oxygen is mixed and causing a collision of the swirl flows. Additionally, it is described that ozone water containing ozone nano bubbles is generated by irradiating the generated oxygen nano bubble water with ultraviolet ray.

In a liquid containing ultrafine bubbles (hereinafter, also referred to as “UFBs”) (nano bubbles) smaller than 1.0 μm in diameter, it is desired that the UFBs do not rise and remain in the liquid. The rising speed of the bubbles can be calculated by Stokes' law, and the speed is proportional to the square of a particle diameter. Therefore, the particle diameter of the UFBs has a great effect as a speed factor, and the particle diameter of the UFBs affects greatly the reliability of the liquid containing the UFBs. In order to obtain a UFB liquid with high reliability, it is desirable to make the particle diameters of the UFBs uniform to about 100 nm to suppress the rising speed.

### CITATION LIST

### Patent Literature

PTL 1: Japanese Patent Laid-Open No. 2011-200778

### SUMMARY OF THE INVENTION

However, the bubbles obtained by the method in PTL 1 include bubbles greater than the desirable particle diameter, and those bubbles greater than the desirable particle diameter rise and disappear over time. As a result, there is a problem that it is impossible to obtain a UFB liquid that can be stored long-term at a high concentration.

Therefore, the present invention provides a device for generating an ozone-containing UFB liquid and a method for generating the ozone-containing UFB liquid, which enable the generation of the ozone-containing UFB liquid that can be stored long-term at a high concentration.

### Solution to Problem

Therefore, a device for generating an ozone-containing ultrafine bubble liquid of the present invention includes: an ultrafine bubble generating unit that generates an ultrafine bubble liquid containing ultrafine bubbles by applying energy to a liquid and ejecting the liquid from an ejecting port having a small diameter; and a radiating unit that irradiates the ultrafine bubble liquid with ultraviolet ray.

### Advantageous Effects of Invention

Further features of the present invention will become apparent from the following description of exemplary embodiments with reference to the attached drawings.

### BRIEF DESCRIPTION OF THE DRAWINGS

FIG. 1 is a schematic view illustrating an example of an ozone-containing UFB liquid generating device.

FIG. 2 is a schematic view illustrating a UFB generating unit.

FIG. 3 is a schematic view illustrating a UFB generating unit.

FIG. 4 is a schematic view illustrating a UFB generating unit.

FIG. 5 is a schematic view illustrating an example of an ozone-containing UFB liquid generating device.

FIG. 6 is a schematic view illustrating an example of an ozone-containing UFB liquid generating device.

FIG. 7 is a schematic view illustrating an example of an ozone-containing UFB liquid generating device.

### DESCRIPTION OF THE EMBODIMENTS

### First Embodiment

A first embodiment of the present invention is described below with reference to the drawings. Note that, the following embodiment is not intended to limit the present invention. Note that, in the present specification, an ozone-containing ultrafine bubble liquid means that a liquid containing ultrafine bubbles (hereinafter, also referred to as UFBs) contains ozone. That is, the ozone may exist as the UFBs in the liquid or may exist in a state of being dissolved in the liquid.

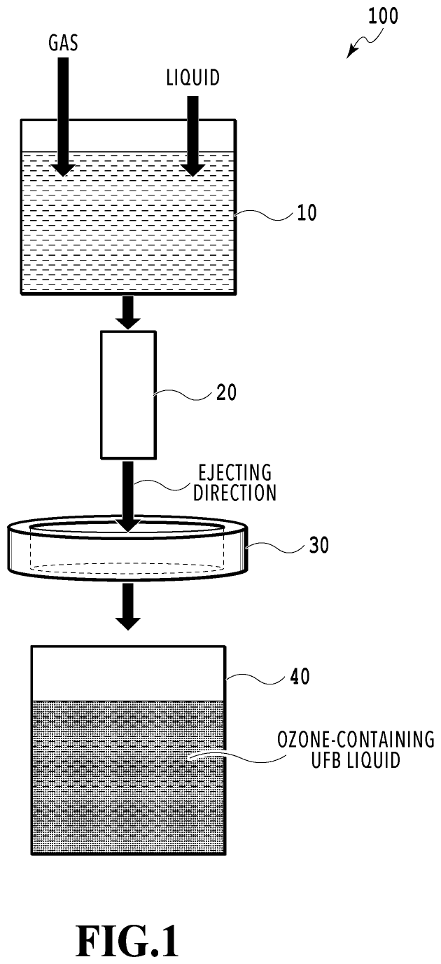

FIG. 1 is a schematic view illustrating an example of an ozone-containing UFB liquid generating device 100 to which the present embodiment is applicable. The ozone-containing UFB liquid generating device 100 includes a gas dissolving tank 10, a UFB generating unit (ultrafine bubble generating unit) 20, an ultraviolet ray light 30, and a collecting unit 40. A liquid and a gas to be dissolved into the liquid are supplied to the gas dissolving tank 10 to produce a gas solution.

The gas herein indicates air in a use environment of the device; however, it is not limited thereto. As the gas, oxygen, nitrogen, hydrogen, ozone, helium, carbon dioxide, methane, ethane, propane, butane, chlorine, chlorine dioxide, and the like are preferable modes, and additionally, mixed gas of the above is also a preferable mode. Moreover, clean dry air (a unit in which a dust filter and a mist filter, a moisture removal heater, or the like are inserted, the unit in some cases additionally including a chemical filter), dry air (air from which moisture is removed as above), and clean dry air (air from which a particle is removed as above) are also preferable modes.

Additionally, although the liquid is not particularly limited and may be water, an organic liquid, an ionic liquid, or the like, water is a favorable mode. A unit that supplies the gas solution to the gas dissolving tank 10 is not particularly limited; however, in an example of using water, the water may be supplied from a water pipe through piping, or moisture in the atmospheric air may be supplied as dew condensation water by using a Peltier element. In a case where degassed water is used, with the supplying to the gas dissolving tank 10 under a desired gas atmosphere, the water in which the gas is dissolved is generated according to Henry's law. Under being open to the atmospheric air, water in which oxygen of substantially 8.4 ppm is dissolved is obtained at room temperature, and under an oxygen atmosphere, an oxygen solution of 45 ppm is obtained.

The water may include purified water with high purity (hyper pure water), tap water, and hard water. Additionally, solute and the like dissolved therein (electrolyte formed by dissociation of sodium chloride, silver nitrate, and the like, free available chlorine, amino acid, sugar, buffer, dye, and so on) may be contained, or dispersion and the like (pigment, dispersant, cell, air bubble, emulsion, titanium oxide, emulsifier, and so on) may be contained.

As the organic liquid, an organic solvent such as alcohols, esters, ketones, a polymerizable liquid monomer, oil formed of hydrogen carbide, siloxane, and the like, a flammable liquid such as gasoline, a non-flammable liquid formed of compounds of fluorine and halogen, and so on are preferable. Additionally, it is also possible to use as a mixed solvent. Moreover, a solute and the like dissolved therein (oil-soluble dye, organic low molecule, organic polymer, inorganic polymer) may be contained, and dispersion and the like (air bubble, emulsion, emulsifier, and so on) may be contained.

Furthermore, use as a mixed liquid of the water and the organic liquid is also possible. Although a water-soluble organic solvent (water-soluble liquid) to be used is not particularly limited, the followings can be a specific example. An alkyl alcohol group of the carbon number of 1 to 4 including methyl alcohol, ethyl alcohol, n-propyl alcohol, isopropyl alcohol, n-butyl alcohol, sec-butyl alcohol, tert-butyl alcohol, and so on. An amide group including N-methyl-2-pyrrolidone, 2-pyrrolidone, 1,3-dimethyl-2-imidazolidinone, N,N-dimethylformamide, N,N-dimethylacetamide, and so on. A keton or ketoalcohol group including acetone, diacetone alcohol, and so on. A cyclic ether group including tetrahydrofuran, dioxane, and so on. A glycol group including ethylene glycol, 1,2-propylene glycol, 1,3-propylene glycol, 1,2-butanediol, 1,3-butanediol, 1,4-butanediol, 1,5-pentanediol, 1,2-hexanediol, 1,6-hexanediol, 3-methyl-1,5-pentanediol, diethylene glycol, triethylene glycol, thiodiglycol, and so on. A group of lower alkyl ether of polyhydric alcohol including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, and so on. A polyalkylene glycol group including polyethylene glycol, polypropylene glycol, and so on. A triol group including glycerin, 1,2,6-hexanetriol, trimethylolpropane, and so on. These water-soluble organic solvents may be used individually, or two or more of them may be used together.

Additionally, as the liquid of the gas solution, it is also possible to use a liquid derived from living body such as, specifically, blood and spinal fluid.

The gas solution generated by the gas dissolving tank 10 is supplied to the UFB generating unit 20. With the UFB generating unit 20 applying a dynamic pressure and the like to the gas solution, a liquid droplet containing the UFBs is ejected (hereinafter, spraying is also referred to as ejecting) from an ejecting port of the UFB generating unit 20 having a small diameter. The ejected liquid droplet (UFB liquid) passes through the inside of a ring of the ultraviolet ray light 30 in the form of a ring and is collected into the collecting unit 40. In this process, with the UFB liquid being irradiated with ultraviolet ray, oxygen in the oxygen atmospheric air and in the liquid absorbs the ultraviolet ray and dissociates into an oxygen atom, the oxygen atom binds to an oxygen molecule, ozone is generated, and the UFB liquid is collected as the ozone-containing UFB liquid. An average particle diameter of the thus-generated ultrafine bubbles is 200 nm or smaller, and a particle diameter distribution is smaller than 3.

As the ultraviolet ray light 30, it is favorable to have an absorption wavelength of the oxygen molecule, a light having a wavelength of 170 nm or greater and 240 nm or smaller is preferred, and a publicly known light can also be used. For example, a low-pressure mercury light using quartz for glass is representative; however, a recent mercury-free ozone light can also obtain a similar effect. Specifically, an excimer light, CARE222 (manufactured by Ushio Inc.), and the like may be included. As a matter of course, as a member used for a light path, a transparent material such as quartz glass is used for usage without blocking the light of the above wavelength.

Note that, as a wetted member of the ozone-containing UFB liquid after the irradiation of ultraviolet ray, it is preferable to use a material having resistance to ozone. As a material having resistance to ozone, if it is metal, titanium is preferably used, if it is resin, a fluoropolymer (PFA, PTFE, and the like) is preferably used, and if it is glass, quartz and the like are preferably used.

Note that, in the present embodiment, an example using the ultraviolet ray light 30 in the form of a ring is used as the ultraviolet ray light is described; however, it is not limited thereto. Any shape is applicable as long as it is possible to irradiate the ejected liquid droplet with ultraviolet ray.

Although details of the reason why the thus-obtained ozone-containing UFB liquid is able to be stored long-term at a high concentration are unknown, the present inventors assume the reason as follows.

According to Henry's law, the gas is dissolved into the liquid in accordance with the partial pressure of the gas and the solubility of the gas with respect to the liquid. It is inferred that, because the UFBs are contained in the liquid, the equilibrated state between the gas in the UFBs and the gas dissolved in the liquid is maintained. Therefore, if there is excessive ozone in the atmospheric air, the ozone is dissolved into the liquid so as to maintain the equilibrium accordingly. Additionally, the dissolved ozone is vaporized and diffused into the UFBs so as to maintain the equilibrium with the gas in the UFBs. Likewise, if the ozone in the liquid is consumed, the ozone is supplied from a UFB side so as to maintain the equilibrated state. It is assumed that, as a result, the ozone concentration in the liquid is maintained long-term.

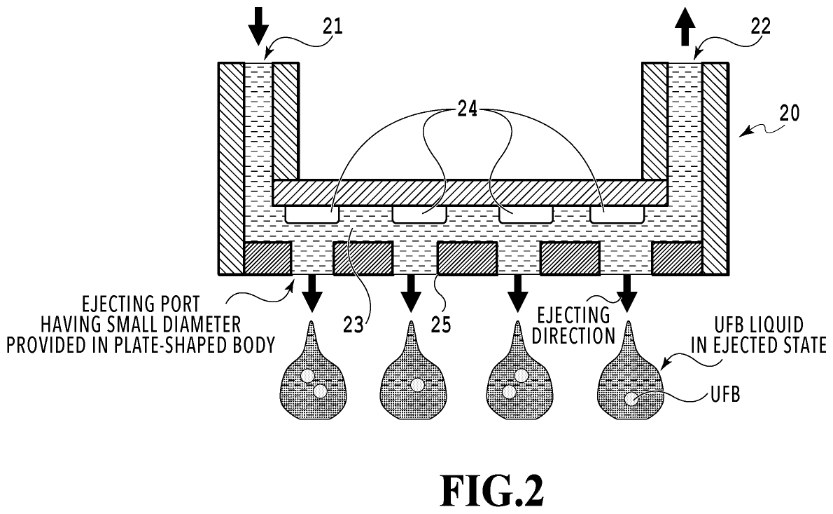

FIG. 2 is a schematic view illustrating the UFB generating unit 20 in the present embodiment. In the UFB generating unit 20, the UFB liquid in the form of a liquid droplet is ejected from an ejecting port 25 having a small diameter by applying ejecting energy to the gas solution circulating in the UFB generating unit 20 (in the ultrafine bubble generating unit). In this case, the ejecting port having a small diameter is an ejecting port of 0.1 μm or greater and 100 μm or smaller in an ejecting port diameter and 0.1 pl or greater and 600 pl or smaller of an ejecting amount, which is described in an example below. The gas solution that enters from a flow passage inlet port 21 exits from a flow passage outlet port 22 through a flow passage 23. Meanwhile, the ejecting energy is applied from a piezoelectric element (dynamic unit) 24 to the gas solution in the flow passage 23, and the UFB liquid in the form of a liquid droplet is ejected from the ejecting port 25. The gas solution that is not ejected exits from the flow passage outlet port 22, passes through a not-illustrated circulating flow passage, and enters again the flow passage 23 from the flow passage inlet port 21. The piezoelectric element 24 is provided in a position facing the ejecting port 25, and the gas solution to which the piezoelectric element 24 applies the ejecting energy is ejected from the ejecting port 25.

In the present embodiment, an example in which the piezoelectric element is used as an element that applies the ejecting energy to the gas solution is described; however, it is not limited thereto. There is no particular limitation as long as it is possible to eject and spray the gas solution, and the ejecting and spraying by changing an air pressure using compressed air and by changing a water pressure using a pump are also preferable modes.

Additionally, increasing the concentration of the UFBs in the UFB liquid by repeating the ejecting and spraying again after the UFB liquid manufactured by the ejecting and spraying is collected is also a preferable mode.

### (Modification)

A modification of the present embodiment is described below.

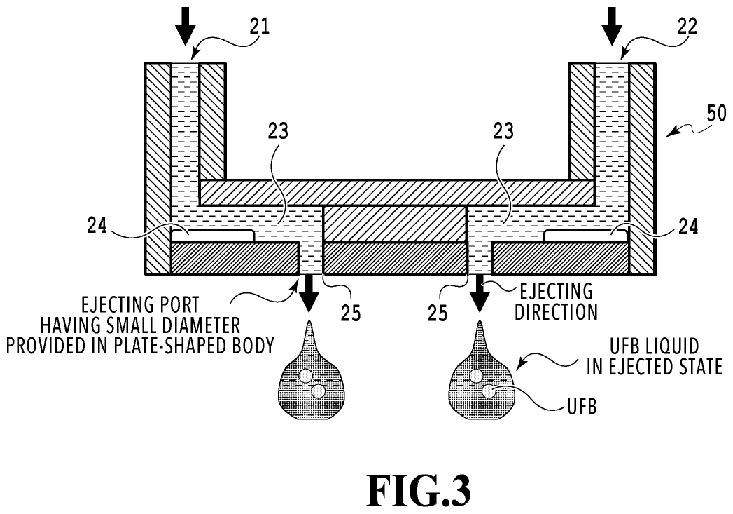

FIG. 3 is a schematic view illustrating a UFB generating unit 50 and is a diagram illustrating the modification of the present embodiment. The UFB generating unit 50 as the modification is different from the above-described UFB generating unit 20 illustrated in FIG. 2 in that the piezoelectric element 24 is provided in a different position. In the UFB generating unit 50, the piezoelectric element 24 is provided in the flow passage 23 that does not face the ejecting port 25, and the UFB liquid is ejected from the ejecting port 25 by changing the pressure of the gas solution in the flow passage 23 by the piezoelectric element 24.

Thus, the ultrafine bubble liquid containing the ultrafine bubbles is generated by applying the energy to the liquid and ejecting the liquid from the ejecting port having a small diameter, and the generated ultrafine bubble liquid is irradiated with ultraviolet ray. Therefore, it is possible to provide a device for generating the ozone-containing UFB liquid and a method for generating the ozone-containing UFB liquid, which enable the generation of the ozone-containing UFB liquid that can be stored long-term at a high concentration.

### Second Embodiment

A second embodiment of the present invention is described below with reference to the drawings. Note that, since the basic configuration of the present embodiment is similar to that of the first embodiment, a characteristic configuration is described below.

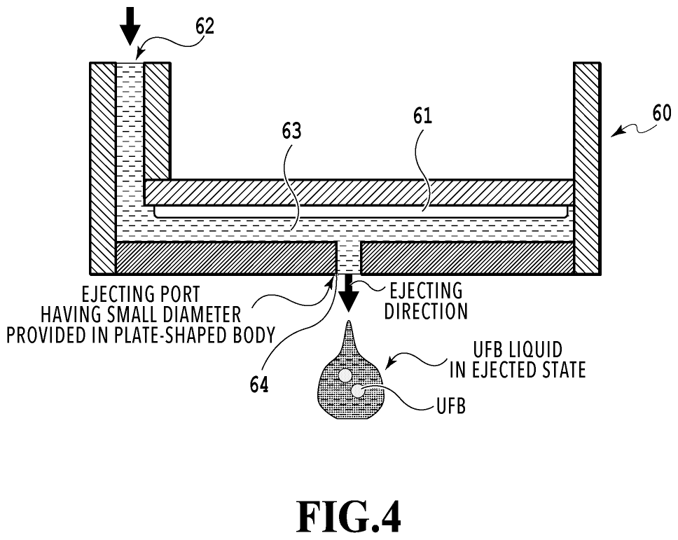

FIG. 4 is a schematic view illustrating a UFB generating unit 60 in the present embodiment. The UFB generating unit 60 includes an ultrasonic oscillator 61 as the element that applies the ejecting energy to the gas solution. The UFB generating unit 60 in the present embodiment does not have a configuration of circulating the gas solution, and the gas solution that enters a flow passage 63 from a flow passage inlet port 62 is ejected from an ejecting port 64. In the ejecting, the UFB liquid is ejected from the ejecting port 64 arranged in an ejecting port surface in the form of a plate by applying oscillation to the gas solution in the flow passage 63 by the ultrasonic oscillator 61.

### Third Embodiment

A third embodiment of the present invention is described below with reference to the drawings. Note that, since the basic configuration of the present embodiment is similar to that of the first embodiment, a characteristic configuration is described below.

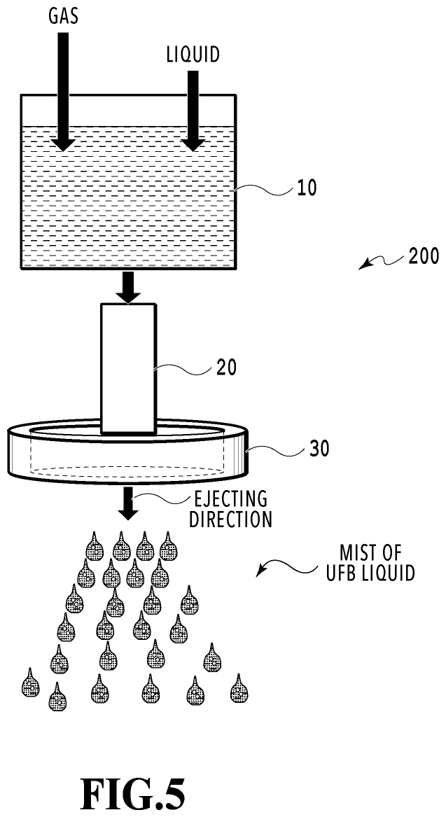

FIG. 5 is a schematic view illustrating an example of an ozone-containing UFB liquid generating device 200 to which the present embodiment is applicable. The ozone-containing UFB liquid generating device 200 includes the gas dissolving tank 10, the UFB generating unit 20, and the ultraviolet ray light 30. In a case where the liquid is used for the purpose of being nebulized and sprayed to a space as a method of using the ozone-containing UFB liquid, a preferable mode is that the ejected UFB liquid immediately after manufacturing is irradiated with ultraviolet ray in a state of flying and is sprayed immediately.

In the present embodiment, the UFB liquid ejected from the UFB generating unit 20 is irradiated with ultraviolet ray by passing through the inside of the ring of the ultraviolet ray light 30, ozone is generated, and the UFB liquid is sprayed to a space as the ozone-containing UFB liquid.

The dissolving efficiency of the gas into the liquid is positively correlated with a surface area (interface) per volume of the liquid, and since a proportion of the interface of the ejected and sprayed liquid droplet is higher than that of the liquid in bulk, the efficiency of containing ozone is excellent. Additionally, in the spraying, in order to improve the flying distance, providing a blowing fan for the blowing to the liquid droplet is also a preferable mode. Moreover, since the time required to dry the ejected liquid droplet is correlated with the size of the liquid droplet, it is possible to increase the drying time by increasing the size of the ejected liquid droplet. To this end, increasing the liquid droplet in size by causing a collision and unifying of the liquid droplets ejected from the UFB generating unit 20, and irradiating the enlarged liquid droplet with ultraviolet ray by the ultraviolet ray light 30 in a flying space is also a preferable mode.

As a method of unifying the liquid droplets, a preferable mode is that multiple ejecting ports are arrayed in a non-parallel state, the ejecting ports are provided such that the liquid droplets cross each other after ejecting, and the liquid droplets are unified after ejecting. Additionally, apposing UFB generating units in a non-parallel state, and ejecting the liquid droplets to cross each other after ejecting so as to unify the liquid droplets is also a preferable mode.

### Fourth Embodiment

A fourth embodiment of the present invention is described below with reference to the drawings. Note that, since the basic configuration of the present embodiment is similar to that of the first embodiment, a characteristic configuration is described below.

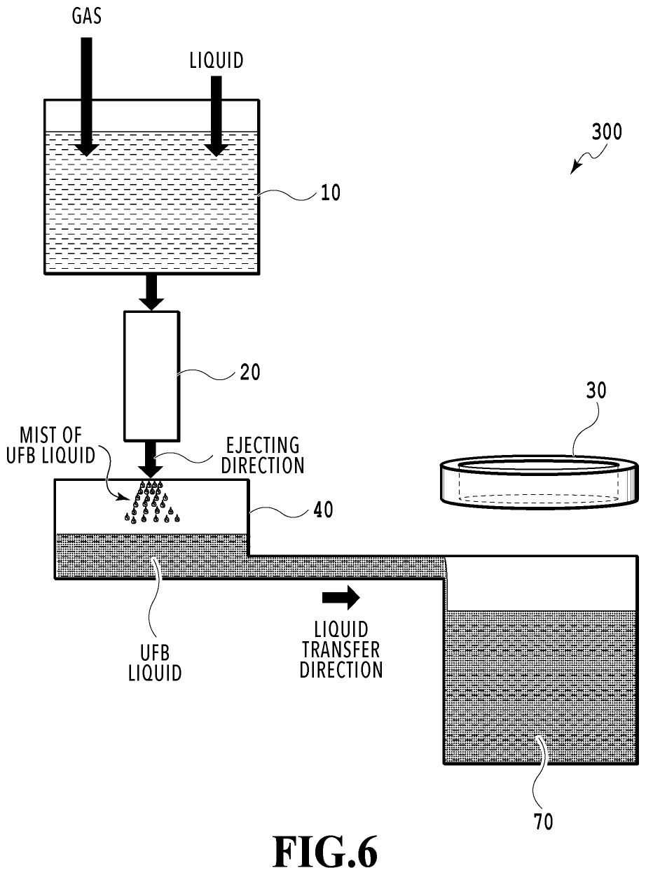

FIG. 6 is a schematic view illustrating an example of an ozone-containing UFB liquid generating device 300 to which the present embodiment is applicable. The ozone-containing UFB liquid generating device 300 includes the gas dissolving tank 10, the UFB generating unit 20, the ultraviolet ray light 30, the collecting unit 40, and a retaining unit 70. In a case where the ozone-containing UFB liquid is used as the liquid in bulk as a method of using the ozone-containing UFB liquid, collecting the liquid without the irradiation of ultraviolet ray, and thereafter irradiating the collected liquid with the ultraviolet ray is also a preferable mode.

In the present embodiment, the UFB liquid ejected from the UFB generating unit 20 is collected by the collecting unit 40 and transferred to the retaining unit 70. The UFB liquid retained in the retaining unit 70 is irradiated with ultraviolet ray by the ultraviolet ray light 30. With the irradiation with ultraviolet ray, ozone is generated in the UFB liquid in the retaining unit 70, and the ozone-containing UFB liquid is obtained.

### Fifth Embodiment

A fifth embodiment of the present invention is described below with reference to the drawings. Note that, since the basic configuration of the present embodiment is similar to that of the first embodiment, a characteristic configuration is described below.

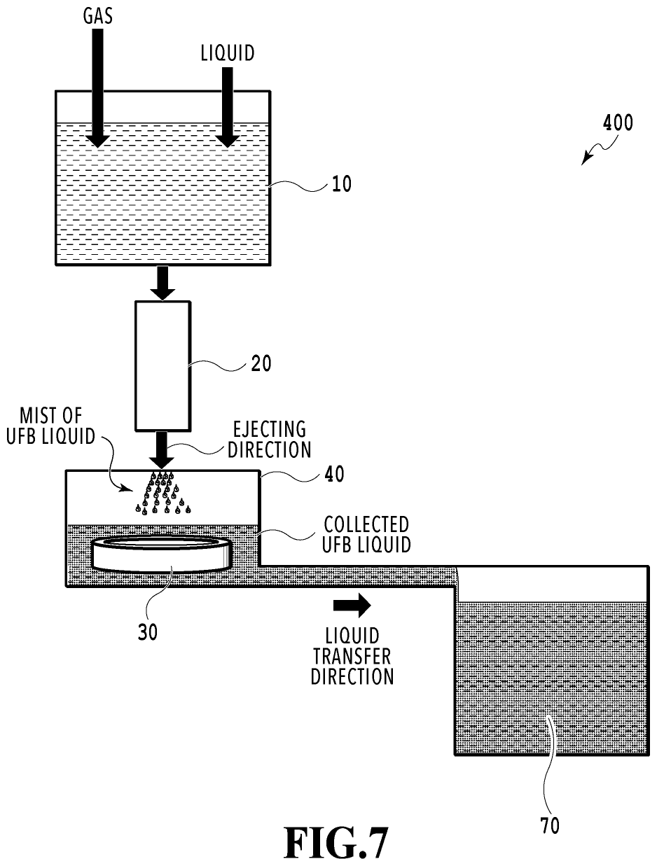

FIG. 7 is a schematic view illustrating an example of an ozone-containing UFB liquid generating device 400 to which the present embodiment is applicable. The ozone-containing UFB liquid generating device 400 includes the gas dissolving tank 10, the UFB generating unit 20, the ultraviolet ray light 30, the collecting unit 40, and the retaining unit 70. In a case where the ozone-containing UFB liquid is used as the liquid in bulk as a method of using the ozone-containing UFB liquid, providing the ultraviolet ray light 30 in a collecting container, and irradiating ultraviolet ray in the liquid is also a preferable mode. In this case, providing a stirrer in the collecting container to stir the collected liquid and increasing the speed of ozonation is also a preferable mode.

In the present embodiment, the ultraviolet ray light 30 is provided in the collecting unit 40, and the UFB liquid ejected from the UFB generating unit 20 and collected into the collecting unit 40 is irradiated with ultraviolet ray by the ultraviolet ray light 30 in the collecting unit 40. The ozone-containing UFB liquid in which ozone is generated by the irradiation with ultraviolet ray is transferred to the retaining unit 70 and retained by the retaining unit 70.

### EXAMPLES

Overview of a test model to implement the device for generating the ozone-containing UFB liquid of the above-described embodiments and conditions in generating the ozone-containing UFB liquid and results of the testing are described as some examples.

In the UFB generating unit 20, 320 piezoelectric elements 24 were arranged on a single substrate, and 320 ejecting ports 25 were provided. A pulse signal (pulse width: 1.0 μs, voltage: 24 V) was applied at a driving frequency of 20 kHz to those piezoelectric elements 24, water in accordance with each condition of the examples was supplied, and various types of UFB liquids were produced experimentally.

The various types of UFB liquids produced experimentally were irradiated with ultraviolet ray from the ultraviolet ray light to generate the ozone-containing UFB liquid. As the ultraviolet ray light, a low-pressure mercury light of 0.3 A and 4.1 W having an emission wavelength of 184.9 nm and 253.7 nm was used. An ozone concentration was measured based on a predetermined color reaction.

A measuring instrument manufactured by SHIMADZU CORPORATION (model number SALD-7500) was used to measure the UFBs. An average particle diameter (calculated in terms of the number), a concentration (an accumulated number of particles per ml with a particle diameter of 20 μm or smaller), and a particle diameter distribution (a ratio (dw/dn) between an average particle diameter (dw) calculated in terms of the volume and an average molecule amount (dn) calculated in terms of the number, the minimum value is 1) of the UFBs contained in the UFB liquid were measured.

### Example 1

Ultrapure water in which the air is saturated and dissolved was used and was ejected and sprayed from the multiple ejecting ports 25 by the piezoelectric elements 24 to generate the UFB liquid, and the generated UFB liquid was irradiated with ultraviolet ray to obtain the ozone-containing UFB liquid. A hole diameter of the ejecting port 25 in the UFB generating unit 20 was 20 μm, and the ejecting amount was 25 pl, which was calculated from the consumed amount of the supplied liquid per pulse. As an amount of mixed impurities in the obtained ozone-containing UFB liquid, superior or inferior of contamination was determined based on a measurement result of a chemical oxygen demand amount (COD).

A notable positive effect of the ozone-containing UFB liquid is a sterilization function, and the effect was also tested in the present consideration based on the sterilization capability. Into a water solution containing about 100 coliform bacteria and Staphylococcus aureus/ml, the same amount of the ozone-containing water was added, and the sterilization effect was tested. A product name “SAN-AI bio-checker TTC” (manufactured by SAN-AI OBBLI CO., LTD.) was used to execute an evaluation of the number of bacteria at the beginning and after the testing.

### Example 2

The ozone-containing UFB liquid was generated as with Example 1 except that the ultraviolet ray light was changed to an excimer light in the Example 1.

### Example 3

The ozone-containing UFB liquid was generated as with the Example 1 except that the ejection was performed from a single ejecting port 25 in the UFB generating unit 20, and the ultraviolet ray light was changed to CARE222 (manufactured by Ushio Inc.) in the Example 1.

### Example 4

The ozone-containing UFB liquid was generated as with the Example 1 except that an operation voltage in the UFB generating unit 20 was reduced, and the ejecting amount was changed to 0.1 pl in the Example 1.

### Example 5

The ozone-containing UFB liquid was generated as with the Example 1 except that the operation voltage in the UFB generating unit 20 was reduced, and the ejecting amount was changed to 0.08 pl in the Example 1.

### Example 6

The ozone-containing UFB liquid was generated as with the Example 1 except that the operation voltage in the UFB generating unit 20 was increased, and the ejecting amount was changed to 600 pl in the Example 1.

### Example 7

The ozone-containing UFB liquid was generated as with the Example 1 except that the operation voltage in the UFB generating unit 20 was increased, and the ejecting amount was changed to 620 pl in the Example 1.

### Example 8

The ozone-containing UFB liquid was generated as with the Example 1 except that the hole diameter of the ejecting port in the UFB generating unit 20 was changed to 0.1 μm in the Example 1.

### Example 9

The ozone-containing UFB liquid was generated as with the Example 1 except that the hole diameter of the ejecting port in the UFB generating unit 20 was changed to 0.08 μm in the Example 1.

### Example 10

The ozone-containing UFB liquid was generated as with the Example 1 except that the hole diameter of the ejecting port in the UFB generating unit 20 was changed to 100 μm in the Example 1.

### Example 11

The ozone-containing UFB liquid was generated as with the Example 1 except that the hole diameter of the ejecting port in the UFB generating unit 20 was changed to 105 μm in the Example 1.

### Example 12

The ozone-containing UFB liquid was generated as with the Example 1 except that the energy for the ejection was generated by supplying the compressed air intermittently (0.2 MPa, driving at 1 Hz) instead of the piezoelectric element in the UFB generating unit 20 in the Example 1.

### Example 13

The ozone-containing UFB liquid was generated as with the Example 1 except that the energy for the ejection was generated by the ultrasonic oscillator (transmission frequency 21 kHz, driving at 1 Hz) instead of the piezoelectric element in the UFB generating unit 20 in the Example 1.

### Example 14

The ozone-containing UFB liquid was generated as with the Example 1 except that the energy for the ejection was generated by supplying water by a diaphragm pump intermittently (0.2 MPa, driving at 10 Hz sine wave) instead of the piezoelectric element in the UFB generating unit 20 in the Example 1.

### Example 15

The ozone-containing UFB liquid was generated as with Example 2 except that silver nitrate of a molecular concentration of 0.01 M (mol/L) was dissolved into ultrapure water in which the air is saturated and dissolved in the Example 2. Additionally, the ozone-containing UFB liquid in which silver nitrate was dissolved was sprayed onto a glass substrate and dried in air directly. A similar operation was also performed with the ozone-containing UFB liquid of the Example 2 as a comparison target. After each air-dried glass plate was placed in an indoor open space for a week, the product name “SAN-AI bio-checker TTC” (manufactured by SAN-AI OBBLI CO., LTD.) was used to execute a stamp test, and as a result of testing the evaluation of the number of viable bacteria, it was confirmed that the antimicrobial property was 90% against the comparison target.

### Example 16

The ozone-containing UFB liquid was generated as with Example 15 except that the ultrapure water in which the air is saturated and dissolved was irradiated with ultrasonic wave, and 0.1 wt % of silver nanoparticle (reduced silver powder; primary particle diameter of 50 nm, density of 2.2 g/cm2, specific surface area of 14 m2/g) was dispersed in the Example 15. As a result of testing the evaluation of the number of viable bacteria, it was confirmed that the antimicrobial property was 75% against the comparison target.

### Example 17

The ozone-containing UFB liquid was generated as with the Example 15 except that 0.01 wt % of titanium oxide (manufactured by KISHIDA CHEMICAL CO., LTD.) and 1 wt % of polyethylene glycol 400 were added and stirred in the ultrapure water in which the air is saturated and dissolved, and thereafter the irradiation with ultrasonic wave and dispersion were performed in the Example 15. As a result of testing the evaluation of the number of viable bacteria, it was confirmed that the antimicrobial property was 50% against the comparison target.

### Example 18

The ozone-containing UFB liquid was generated as with the Example 1 except that seawater was used instead of the ultrapure water in which the air is saturated and dissolved in the Example 1.

### Example 19

The ozone-containing UFB liquid was generated as with the Example 1 except that mineral water (product name: contrex, hardness of 1468 mg/L) was used instead of the ultrapure water in which the air is saturated and dissolved in the Example 1.

### Example 20

The ozone-containing UFB liquid was generated as with the Example 1 except that a fluorinated solvent (product name: AMOLEA (registered trademark) AS-300, manufactured by AGC) was used instead of the ultrapure water in which the air is saturated and dissolved in the Example 1.

### Example 21

The ozone-containing UFB liquid was generated as with the Example 1 except that a sterilization light (maximum wavelength of 254 nm) was used instead of the ultraviolet ray light in the Example 1.

### Example 22

The ozone-containing UFB liquid was generated as with the Example 1 except that the liquid in bulk was irradiated with ultraviolet ray by way of an air layer after the UFB-contained liquid was collected in the Example 1.

### Example 23

The ozone-containing UFB liquid was generated as with the Example 1 except that the liquid in bulk was irradiated with ultraviolet ray in the liquid after the UFB-contained liquid was collected in the Example 1.

Some comparative examples are described below to compare with the above-described examples.

### Comparative Example 1

A comparative example sample was produced as with the Example 2 except that the UFB generating unit 20 was immersed in the ultrapure water and driven without the ejecting and spraying, and the liquid was collected in Example 22 or 23.

### Comparative Example 2

A comparative example sample was produced as with the Example 1 except that no irradiation with ultraviolet ray was performed in the Example 1.

### Comparative Example 3

A comparative example sample was produced as with the Example 1 except that ultraviolet ray was changed to a light source of a wavelength of 365 nm in the Example 1.

### Comparative Example 4

A comparative example sample was produced by performing filtration treatment on the ozone-containing UFB liquid manufactured in the Example 1 by using a filtration film (Minimate manufactured by Nihon Pall Ltd.) of a molecular weight cut-off of 500 and collecting a half amount of a transparent liquid.

### Comparative Example 5

A comparative example sample was produced by performing filtration treatment on the ozone-containing UFB liquid manufactured in the Example 1 by using the filtration film (Minimate manufactured by Nihon Pall Ltd.) of the molecular weight cut-off of 500 and collecting a half amount of a concentrated liquid.

### Comparative Example 6

The UFBs were introduced directly through a micropore by a microporous method instead of the UFB generating unit in the Example 22 or 23. Specifically, a gas phase and a water phase were partitioned by a microporous film, a liquid phase was made negative pressure by using a suction pump and circulated, the air was sucked through the micropore, and an air-containing UFB liquid was produced. A filtration film (Minimate manufactured by Nihon Pall Ltd.) of a molecular weight cut-off of 1000 was used as the microporous film. Except this, a comparative example sample was produced as with the Example 1.

### Comparative Example 7

The UFBs were introduced by a swirl flow method instead of the UFB generating unit in the Example 1. Specifically, a sample liquid was generated as with the Example 1 except that, for the execution, instead of the T-UFB generating unit 300, the T-UFB generating unit 300 was changed to a shower head that can generate the UFB liquid (product name: Bollina, manufactured by TANAKA METALS Co., Ltd.).

Table 1 and Table 2 are evaluation results of the evaluation of the sample liquid generated in each example and comparative example described above. Evaluation items and determination criteria are as follows.

For the evaluation of mixed contamination, the chemical oxygen demand amount (color reaction by potassium permaganate) was executed.

The determination criteria are written below.
A 0 or greater and smaller than 5 ppm
B 5 or greater and smaller than 10 ppm
C 10 ppm or greater and smaller than 50 ppm
D 50 ppm or greater

For the sterilization effect, comparative testing against the ultrapure water in a case where a testing liquid is added to a suspension containing coliform bacteria and Staphylococcus aureus was executed by using a bio-checker.

The determination criteria are written below.
A 99% or greater
B 80% or greater and smaller than 99%
C 50% or greater and smaller than 80%
D smaller than 50%

The dissolved ozone concentration at the beginning and after the storage was determined based on the color reaction by oxidative coupling with Trinder reagent. Note that, in a case of reaching the upper limit of the concentration to be measured, dilution with the ultrapure water was performed as needed, and calculation was performed in terms of the concentration. The testing liquid was sealed and stored with no gas phase in a PFA container at room temperature for a week. The determination criteria related to the ozone concentration over time are written below.
A 2 ppm or greater
B 1 ppm or greater and smaller than 2 ppm
C 0.1 ppm or greater and smaller than 1 ppm
D smaller than 0.1 ppm

TABLE 1

| | Example | Example | Example | Example | Example | Example | Example | Example | Example | Example | | |
|---|---|---|---|---|---|---|---|---|---|---|---|---|
| | 1 | 2 | 3 | 4 | 5 | 6 | 7 | 8 | 9 | 10 | | |
| UFB | 3 | 3 | 3.4 | 3.2 | 0.4 | 1.2 | 0.3 | 3.2 | 3.3 | 1.1 | | |
| concentration | | | | | | | | | | | | |
| (100 | | | | | | | | | | | | |
| million) | | | | | | | | | | | | |
| UFB | 108 | 106 | 102 | 103 | 104 | 140 | 180 | 103 | 103 | 142 | | |
| particle | | | | | | | | | | | | |
| diameter | | | | | | | | | | | | |
| UFB | 1.5 | 1.5 | 2.4 | 2.4 | 3.6 | 2.9 | 3.3 | 2.6 | 3.4 | 3.2 | | |
| particle | | | | | | | | | | | | |
| diameter | | | | | | | | | | | | |
| distribution | | | | | | | | | | | | |
| Ozone | 12 | 11 | 3 | 7 | 2 | 9 | 3 | 5 | 2 | 7 | | |
| concentration | | | | | | | | | | | | |
| Chemical | A | A | A | A | A | A | A | A | A | A | | |
| oxygen | | | | | | | | | | | | |
| demand | | | | | | | | | | | | |
| amount | | | | | | | | | | | | |
| Sterilization | A | A | A | A | B | A | B | A | B | A | | |
| effect | | | | | | | | | | | | |
| Storage | A | A | B | B | C | B | C | B | C | B | | |
| stability | | | | | | | | | | | | |
| Example | Example | Example | Example | Example | Example | Example | Example | Example | Example | Example | Example | Example |
| 11 | 12 | 13 | 14 | 15 | 16 | 17 | 18 | 19 | 20 | 21 | 22 | 23 |
| 1.1 | 0.3 | 0.2 | 0.25 | 0.6 | ND | ND | 3 | 3 | 3 | 3 | 3 | 3 |
| 142 | 150 | 140 | 145 | 140 | ND | ND | 106 | 106 | 230 | 108 | 108 | 108 |
| 3.8 | 4.3 | 6.2 | 5.5 | 3 | ND | ND | 1.7 | 1.8 | 4.8 | 1.5 | 1.5 | 1.5 |
| 5 | 6 | 5 | 5 | 4 | 4 | 3 | 11 | 11 | 8 | 0.3 | 3 | 4 |
| A | A | A | A | A | B | B | A | A | A | B | A | A |
| B | A | A | A | A | A | A | A | A | A | A | A | A |
| C | C | C | C | C | C | C | B | C | C | B | A | A |

TABLE 2

| | Comparative | Comparative | Comparative | Comparative | Comparative | Comparative | Comparative |
|---|---|---|---|---|---|---|---|
| | Example | Example | Example | Example | Example | Example | Example |
| | 1 | 2 | 3 | 4 | 5 | 6 | 7 |
| UFB | 0 | 3 | 3 | 0 | 3.1 | 0.4 | 0.2 |
| concentration | | | | | | | |
| (100 | | | | | | | |
| million) | | | | | | | |
| UFB | 0 | 108 | 108 | 0 | 108 | 240 | 330 |
| particle | | | | | | | |
| diameter | | | | | | | |
| UFB | — | 1.5 | 1.5 | — | 1.9 | 8.5 | 11.4 |
| particle | | | | | | | |
| diameter | | | | | | | |
| distribution | | | | | | | |
| Ozone | 3 | 0 | 0 | 0.2 | 0.2 | 0.2 | 0.2 |
| concentration | | | | | | | |
| Chemical | A | A | A | D | D | D | C |
| oxygen | | | | | | | |
| demand | | | | | | | |
| amount | | | | | | | |
| Sterilization | A | C | C | C | C | C | C |
| effect | | | | | | | |
| Storage | D | D | D | D | D | D | D |
| stability | | | | | | | |

Note that, a configuration applicable to each example described above may be applied to each embodiment described above. Additionally, the examples described above may be executed in combination as needed.

### REFERENCE SIGNS LIST

10 gas dissolving tank
20 UFB generating unit
24 piezoelectric element
25 ejecting port
30 ultraviolet ray light
40 collecting unit
61 ultrasonic oscillator
70 retaining unit
100 ozone-containing UFB liquid generating device
200 ozone-containing UFB liquid generating device
300 ozone-containing UFB liquid generating device
400 ozone-containing UFB liquid generating device

According to the present invention, it is possible to provide a device for generating an ozone-containing UFB liquid and a method for generating the ozone-containing UFB liquid, which enable the generation of the ozone-containing UFB liquid that can be stored long-term at a high concentration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A device for generating an ozone-containing ultrafine bubble liquid, comprising:
an ultrafine bubble generating unit that generates an ultrafine bubble liquid containing ultrafine bubbles by applying energy to a liquid and ejecting the liquid from an ejecting port having a small diameter; and
a radiating unit that irradiates the ultrafine bubble liquid with ultraviolet ray.

2. The device for generating the ozone-containing ultrafine bubble liquid according to claim 1, wherein
the ultrafine bubble generating unit includes a dynamic unit that applies energy to eject the liquid.

3. The device for generating the ozone-containing ultrafine bubble liquid according to claim 2, wherein
the dynamic unit is a piezoelectric element.

4. The device for generating the ozone-containing ultrafine bubble liquid according to claim 2, wherein
the dynamic unit is an ultrasonic oscillator.

5. The device for generating the ozone-containing ultrafine bubble liquid according to claim 1, wherein
the ultrafine bubble generating unit ejects the liquid from a plurality of ejecting ports having a small diameter by applying the energy to the liquid.

6. The device for generating the ozone-containing ultrafine bubble liquid according to claim 1, further comprising:
a collecting unit that collects a liquid droplet ejected from the ultrafine bubble generating unit.

7. The device for generating the ozone-containing ultrafine bubble liquid according to claim 1, wherein
the radiating unit irradiates a liquid droplet ejected from the ultrafine bubble generating unit with ultraviolet ray.

8. The device for generating the ozone-containing ultrafine bubble liquid according to claim 7, wherein
the ultrafine bubble generating unit unifies the ejected liquid droplets.

9. The device for generating the ozone-containing ultrafine bubble liquid according to claim 6, wherein
the radiating unit irradiates the ultrafine bubble liquid ejected from the ultrafine bubble generating unit and collected by the collecting unit with ultraviolet ray.

10. The device for generating the ozone-containing ultrafine bubble liquid according to claim 9, wherein
the radiating unit is provided in the collecting unit.

11. The device for generating the ozone-containing ultrafine bubble liquid according to claim 9, further comprising:
a retaining unit that retains the ultrafine bubble liquid transferred from the collecting unit, wherein
the radiating unit irradiates the ultrafine bubble liquid retained in the retaining unit with ultraviolet ray.

12. The device for generating the ozone-containing ultrafine bubble liquid according to claim 1, wherein
the ultrafine bubble generating unit ejects the liquid circulating in the ultrafine bubble generating unit.

13. The device for generating the ozone-containing ultrafine bubble liquid according to claim 1, wherein
a diameter of the ejecting port is 0.1 μm or greater and 100 μm or smaller.

14. The device for generating the ozone-containing ultrafine bubble liquid according to claim 1, wherein
an ejecting amount ejected from the ejecting port is 0.1 pl or greater and 600 pl or smaller.

15. The device for generating the ozone-containing ultrafine bubble liquid according to claim 1, wherein
ultraviolet ray radiated by the radiating unit has a wavelength of 170 nm or greater and 240 nm or smaller.

16. The device for generating the ozone-containing ultrafine bubble liquid according to claim 1, wherein
an average particle diameter of the ultrafine bubbles generated by the ultrafine bubble generating unit is 200 nm or smaller, and a particle diameter distribution is smaller than 3.

17. The device for generating the ozone-containing ultrafine bubble liquid according to claim 1, wherein
the liquid is a water-soluble liquid.

18. A method for generating an ozone-containing ultrafine bubble liquid, comprising:
generating an ultrafine bubble liquid containing ultrafine bubbles by applying energy to a liquid and ejecting the liquid from an ejecting port having a small diameter; and
irradiating the ultrafine bubble liquid with ultraviolet ray.
